(19) United States
(12) Patent Application Publication
(10) Pub. No.: US 2014/0161028 A1
(43) Pub. Date: Jun. 12, 2014

(54) DIGITAL MOBILE RADIO FRONT END PROCESSOR

(71) Applicant: AT&T MOBILITY II LLC, Atlanta, GA (US)

(72) Inventor: Arturo Maria, Bellevue, WA (US)

(73) Assignee: AT&T MOBILITY II LLC, Atlanta, GA (US)

(21) Appl. No.: 13/708,473

(22) Filed: Dec. 7, 2012

(51) Int. Cl. H04W 80/04

(52) U.S. Cl. CPC H04W 80/045
USPC 370/328; 370/467

(57) ABSTRACT

Front-end processors are provided that receive an identifier representative of a target device and match the identifier with a device type. The identifier can be received from a first device that utilizes a first communication protocol and the target device can utilize a second communication protocol. Communications received from the first device and intended for the target device can be translated from the first communication protocol to the second communication protocol. The communication, translated to the second communication protocol type can be transmitted to the target device for reception at the target device.

### TECHNICAL FIELD

The subject disclosure relates to wireless communications and, also generally, to digital mobile radio front end processors in a wireless communications environment.

### BACKGROUND

Electric utilities have traditionally used two-way radios to communicate with field crews, particularly in times of natural or man-made disasters and/or other emergencies. In the past, these communications services have used analog radios, which have been improved over time with technological advances. Today, utilities still rely on analog radios, but have implemented digital mobile radios to replace aging devices. The digital mobile radios cannot communicate with other mobile communication devices (e.g., cellular phones). Therefore, utility field crews often carry multiple devices, such as one device to communicate over the digital mobile radio protocol and another device to communicate over a cellular protocol. Carrying more than one device can be cumbersome and can result in user dissatisfaction.

### BRIEF DESCRIPTION OF THE DRAWINGS

Various non-limiting embodiments are further described with reference to the accompanying drawings in which:

FIG. 1 illustrates an example, non-limiting system configured to facilitate communication between digital mobile radio units and other mobile communications devices, according to an aspect;

FIG. 2 illustrates an example, non-limiting embodiment of a network element that can be configured to facilitate communication between disparate devices, according to an aspect;

FIG. 3 illustrates another example, non-limiting embodiment of a network element configured to facilitate communication between devices that utilize different communication protocols, according to an aspect;

FIG. 4 illustrates an example, non-limiting wireless communications network in which the disclosed aspects can be utilized;

FIG. 5 illustrates an example, non-limiting system that employs an artificial intelligence component, which can facilitate automating one or more features in accordance with the disclosed aspects;

FIG. 6 illustrates an example, non-limiting method for facilitating communication between devices that use different communication protocols, according to an aspect;

FIG. 7 illustrates an example, non-limiting method for provisioning a device for communication with a digital mobile radio unit, according to an aspect;

FIG. 8 is a schematic example wireless environment that can operate in accordance with aspects described herein;

FIG. 9 illustrates a block diagram of access equipment and/or software related to access of a network, in accordance with an embodiment; and

FIG. 10 illustrates a block diagram of a computing system, in accordance with an embodiment.

### DETAILED DESCRIPTION

Aspects of the subject disclosure will now be described more fully hereinafter with reference to the accompanying drawings in which example embodiments are shown. In the following description, for purposes of explanation, numerous specific details are set forth in order to provide a thorough understanding of the various embodiments. However, the subject disclosure may be embodied in many different forms and should not be construed as limited to the example embodiments set forth herein.

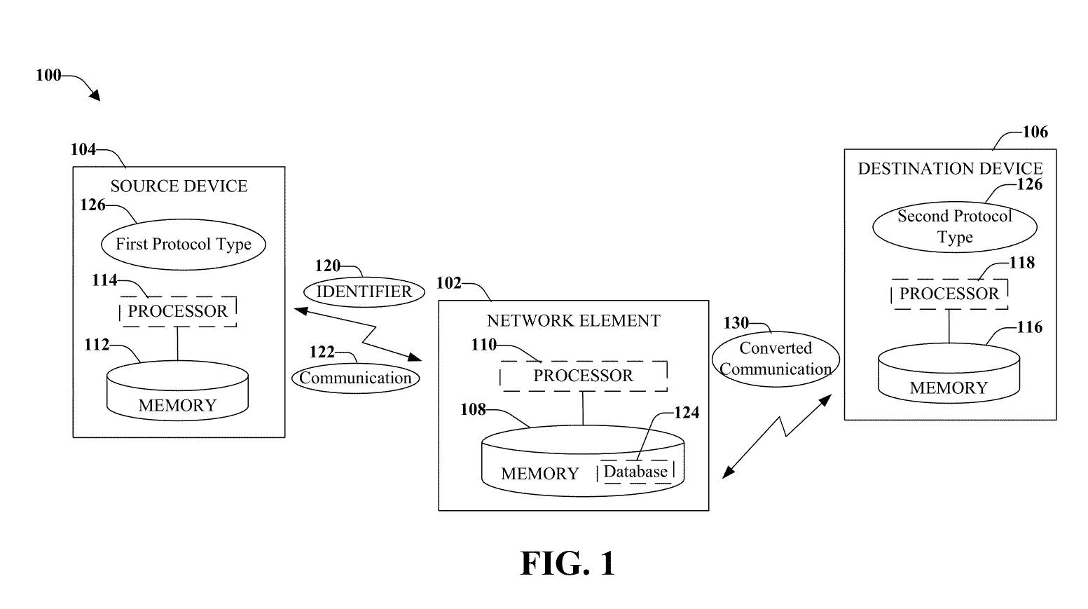

Referring initially to FIG. 1, illustrated is an example, non-limiting system 100 configured to facilitate communication between digital mobile radio units and other mobile communications devices, according to an aspect. Digital mobile radio units are devices that are configured to utilize a communications standard (or communication protocol) referred to as digital mobile radio. The digital mobile radio standard allows for radio transmissions in the 12.5 khz band and provides voice and data services using time division multiple access. Time division multiple access divides a signal into different time slots, which allows multiple users to share the same frequency channel.

Utilities (e.g., electric utilities, gas utilities, and so forth) and/or first responders (e.g., police, fire, and so forth), might use digital mobile radio units (or similar units) for field crews and other mission critical personnel. The digital mobile radio units can be used in various situations including situations where two-way communications are critical and where communications services, which do not rely on cellular carriers, are needed. For example, during an emergency situation, utilities and/or first responders do not want to have to compete for network resources with others that are using a network for non-emergency purposes (e.g., to make a telephone call, to upload a video, to stream music, and so forth).

However, the inability of the digital mobile radio units to communicate over other protocols (e.g., cellular protocols, global system for mobile communication, 3G, 4G, long term evolution, and so forth) allows these units to communicate only with other digital mobile radio units. Therefore, if a user desires to communicate with someone that does not have a digital mobile radio unit, a separate device (e.g., a cellular phone) is necessary. As such, the user carries two or more devices (e.g., a digital mobile radio unit and a cellular phone) in order to communicate over both a digital mobile radio enabled network a non-digital mobile radio protocol enabled network. Carrying more than one device is cumbersome and the need to track the multiple devices can result in one of the devices becoming misplaced and/or stolen.

The ability of allowing a digital mobile radio unit to communicate with cellular devices, as disclosed herein, can in effect make the cellular network an extension of the digital mobile radio network. In a similar manner, the digital mobile radio network can become an extension of the cellular network. This can also provide utilities the ability to use their existing investment in digital mobile radio units (and the digital mobile radio infrastructure) and, at substantially the same time, allow field crews to communicate with millions of users using a mobile cellular network.

System 100 can be configured to bridge the digital mobile radio network(s) and the cellular networks(s). When the disparate networks are bridged together, a digital mobile radio unit can be used to communicate with various devices on the cellular networks(s). In a similar manner, devices on the cellular network(s) can be used to communicate with the digital mobile radio unit. Thus, the user of a digital mobile radio unit can utilize a single device (e.g., the digital mobile radio unit) to communicate with the cellular network while retaining the ability to communicate over the digital mobile radio network when needed (e.g., during an emergency or during another situation).

According to an implementation, system 100 can be configured to provide front-end processors for (in 3G networks) gateway general packet radio service support node devices and/or long term evolution gateway devices that allow mobile cellular devices (e.g., smart phones, tablets, media devices, personal digital assistants, and so forth) to communicate directly with digital mobile radio units. A mobile communications device can be a global system for mobile communication device, a 3G device, a long term evolution device, and so on. The front end processors can provide transparent access from mobile devices to digital mobile radio switches and gateways, which can allow the mobile cellular network to be an extension of the digital mobile radio network.

System 100 includes at least one network element 102 that communicates directly, or indirectly (e.g., through other network elements), with at least one source device 104 and at least one destination device 106. The network element 102 can be, for example, an entity associated with a wireless communications network and can be configured to communicate with other network elements (e.g., a gateway general packet radio service support node device, a long term evolution gateway device, and so forth). According to an implementation, the network element 102 is a digital mobile radio gateway front-end processor. The network element 102 can be configured to convert transmissions, such as Internet protocol transmission that reach the gateway general packet radio service support node and/or long term evolution gateways into protocols that digital mobile radio switches understand and that can be relayed to digital mobile radio devices (or digital mobile radio units).

The network element 102 can be associated with more than one gateway (e.g., Long Term Evolution gateway, general packet radio service support node, digital mobile radio gateway, and so forth). Therefore, the network element 102 can be employed to facilitate implementation of the disclosed aspects and can allow a mobile cellular network and a digital mobile radio network to become extensions of each other. Employing the network element 102 (or front end processor) can reduce the changes needed to the other network elements (e.g., gateway devices) and/or the addition of multiple servers being placed in the wireless communications system.

According to some aspects, more than one network element 102 (e.g., front-end processor) can be included in system 100. For example, a first front-end processor can be integrated with (e.g., contained at least in part in) a digital mobile radio gateway. Further, a second front-end processor can be integrated with a long term evolution gateway and a third front-end processor can be integrated with a gateway general packet radio service support node.

Each of the source device 104 and the destination device 106 can be one of several different types of mobile devices. For example, such devices can be digital mobile radio units, cellular phones, PDAs, computers, and so forth. The source device 104 is the device from which a communication is initiated (e.g., the device on which a call is placed). The destination device 106 is the device to which the communication is directed (e.g., the device that is on the receiving end of the call).

The network element 102 can comprise at least one memory 108 that can store computer executable components and instructions. The network element 102 can also include at least one processor 110, communicatively coupled to the at least one memory 108. In a similar manner, the source device 104 can comprise at least one memory 112 and at least one processor 114, coupled to the at least one memory 112. Further, the destination device 106 can comprise at least one memory 116 and at least a processor 118, communicatively coupled to the at least one memory 116.

Coupling can include various communications including, but not limited to, direct communications, indirect communications, wired communications, and/or wireless communications. The processors 110, 114, 118 can facilitate execution of the computer executable components stored in the respective memories 108, 112, 116. The processors 110, 114, 118 can be directly involved in the execution of the computer executable component(s), according to an aspect. Additionally or alternatively, the processors 110, 114, 118 can be indirectly involved in the execution of the computer executable component(s). For example, the processors 110, 114, 118 can direct one or more components to perform the operations.

It is noted that although one or more computer executable components may be described herein and illustrated as components separate from memory 108, 112, 116 (e.g., operatively connected to memory), in accordance with various embodiments, the one or more computer executable components could be stored in the memory 108, 112, 116. Further, while various components have been illustrated as separate components, it will be appreciated that multiple components can be implemented as a single component, or a single component can be implemented as multiple components, without departing from example embodiments.

The network element 102 can be configured to receive, either directly or indirectly (e.g., through another component) from the source device 104, an identifier 120 of the destination device 106 and a communication 122 intended for the destination device 106. For example, a user can enter a telephone number or another identification (e.g., routing number, Internet protocol address, and so on) of the device to which a call is being placed. The network element 102 evaluates the identifier 120 and determines the type of device (e.g., destination device 106) associated with the identifier 120. The identifier can also contain information regarding the device, Internet protocol address of the device, codes associated with the device, and/or security profiles. Additionally, the identifier can include routing codes that indicate which digital mobile radio gateway (e.g., long term evolution gateway, gateway general packet radio service support node, and so on) that should be used to communicate with the destination device 106.

According to an implementation, the network element 102 can access a look-up table or database 124 that includes information related to a protocol used by a device having the indicated identifier 120. As illustrated, the database 124 can be stored in the memory 108. However, according to other implementations, the database 124 can be stored external to memory 108 and/or external to network element 102 and accessible to network element, as needed. For example, the database 124 can be contained in another network entity and can be assessed by network element 102 over a wireless or wired connection.

The network element 102 can also be configured to determine a protocol type for the communication based, in part, on the device type. For example, the source device 104 can utilize a first protocol type 126 for communications (e.g., digital mobile radio, long term evolution, global system for mobile communication, and so forth) and the destination device 106 can utilize a second protocol type 128 for communications (e.g., digital mobile radio, long term evolution, global system for mobile communication, and so forth). The first protocol type 126 can be a different protocol than the second protocol type 128. Further, the network element 102 can be configured to convert or translate the communication 122 from the first protocol type 126 used by the source device 104 to the second protocol type 128 (e.g., a converted communication 130) that will be recognized and understood by the destination device 106.

Further, network element 102 can be configured to route the communication 130 to the appropriate gateway. For example, if the source device 104 is a digital mobile radio device, the communication might be placed to a Long Term Evolution (LTE) enabled device and/or a Global System for Mobile (GSM) communication device. If the call is being placed to a Long Term Evolution (LTE) enabled device, the network element 102 can route the communication to a long term evolution gateway, which will route the communication to the destination device 106. If the call is being placed to a Global System for Mobile (GSM) communication device, the network element 102 can route the communication to a gateway general packet radio service (GPRS) support node (GGSN), which will route the communication to the destination device 106.

In a similar manner, if the source device is a Long Term Evolution (LTE) enabled device, the call can be routed through the long term evolution gateway to the network element 102 for appropriate processing of the communication (conversion to an appropriate protocol type) and forwarding to the digital mobile radio device (e.g., to a digital mobile radio gateway). Further, if the source device is a Global System for Mobile (GSM) communication enabled device, the communication can be routed through a gateway general packet radio service support node (GGSN) to the network element 102 for appropriate processing of the communication and forwarding to the digital mobile radio device.

For example, the source device can be a digital mobile radio unit associated with a digital mobile radio network and the gateway device can be a gateway general packet radio service support node device associated with a mobile cellular network. Further to this example, translation of the communication can cause the cellular network to become an extension of the digital mobile radio network.

In another example, the source device can be a digital mobile radio unit associated with a digital mobile radio network and the gateway device can be a long term evolution gateway device associated with a mobile cellular network. Further to this example, translation of the communication can cause the cellular network to become an extension of the digital mobile radio network.

It is noted that although various aspects and embodiments are discussed herein with respect to universal mobile telecommunication system and/or Long Term Evolution (LTE), the disclosed aspects are not limited to a universal mobile telecommunication system (UMTS) implementation and/or a Long Term Evolution (LTE) implementation. For example, aspects or features of the disclosed embodiments can be exploited in substantially any wireless communication technology. Such wireless communication technologies can include universal mobile telecommunication system, code division multiple access, Wi-Fi, worldwide interoperability for microwave access, gateway general packet radio service, enhanced gateway general packet radio service, third generation partnership project long term evolution, third generation partnership project 2 ultra mobile broadband, high speed packet access, evolved high speed packet access, high-speed downlink packet access, high-speed uplink packet access, Zigbee, or another IEEE 802.XX technology. Additionally, substantially all aspects disclosed herein can be exploited in legacy telecommunication technologies.

In an example, the source device 104 is a cellular phone and the destination device 106 is a digital mobile radio device. A mobile cellular user could use the cellular phone to “call” the digital mobile radio device by entering the appropriate routing number (of the digital mobile radio device) into the cellular phone. The gateway general packet radio service support node or Long Term Evolution (LTE) gateway front-end processor (e.g., network element 102) would interpret the Internet Protocol (IP) address (or “number”) and forward those Internet protocol packets to the digital mobile radio switch/gateway in the correct protocol for subsequent transmission to the digital mobile radio device (e.g., radio).

According to another example, the source device 104 is a digital mobile radio unit and the destination device is a mobile communications device. The user can enter the appropriate routing code of the mobile communications device into the digital mobile radio unit. The digital mobile radio switch/gateway can route the transmission (e.g., Internet protocol packets) to the gateway general packet radio service support node or Long Term Evolution (LTE) gateway front-end processor (e.g., network element 102), which would route the transmission to the mobile communications device.

In accordance with some implementations, in the case where the source device 104 is not a digital mobile radio unit (e.g., is a different type of mobile communications device), an application, referred to a digital mobile radio application can be executing on the source device 104. The digital mobile radio application can translate a protocol of the source device (e.g., voice over Internet protocol) to a digital mobile radio protocol. The native digital mobile radio voice and/or data protocol can be transmitted to the network element 102. Thus, according to this implementation, the source device performs the communication translation and the network element 102 performs the routing of the communication to the gateway appropriate for the destination device 106.

As discussed herein, system 100 can allow communication to occur between digital mobile radio devices and other mobile communications devices. This can mitigate the need to carry two devices (e.g., a digital mobile radio unit and a cellular phone) and can increase user satisfaction by simplifying the communication process. For example, the user does not have to decide which device to use for a particular communication but can use a single device regardless of the device to which the communication is made, or regardless of the device from which the communication is received.

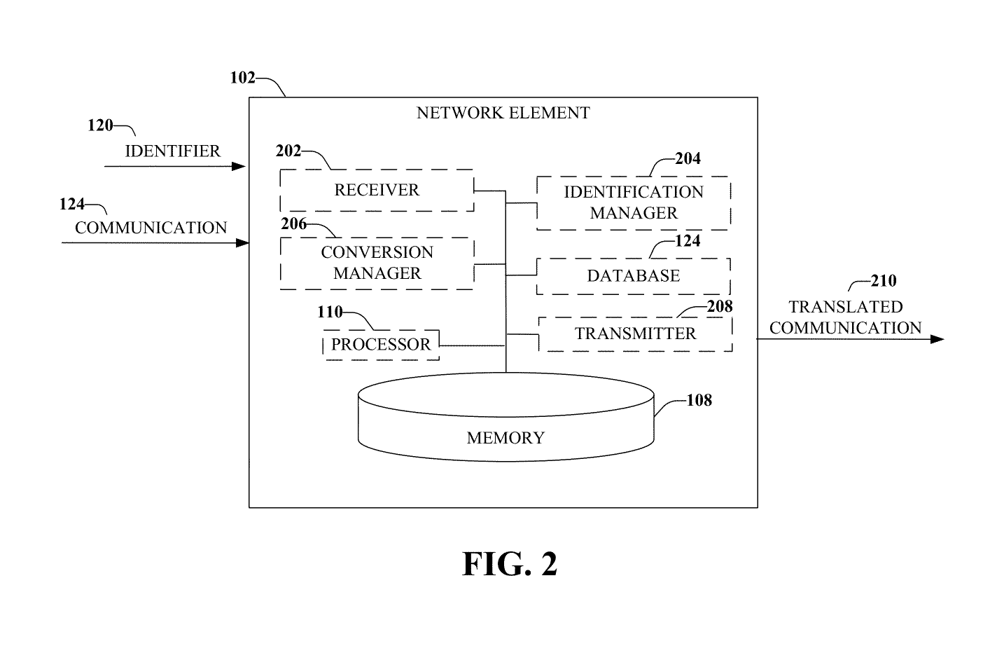

FIG. 2 illustrates an example, non-limiting embodiment of a network element 102 that can be configured to facilitate communication between disparate devices, according to an aspect. For example, the disparate devices can be digital mobile radio units, long term evolution enabled devices, global system for mobile communication enabled devices, and so forth. The network element 102 can include a receiver 202 that can be configured to receive, from a source device, an identifier 120 of a destination device.

For example, if a call is to be placed from a digital mobile radio unit to a cellular device, the appropriate routing code (e.g., telephone number) is input to the digital mobile radio unit (e.g., by a user through interaction with a keyboard, touch screen, voice activation, and so forth). The digital mobile radio unit (source device) conveys the information to the cellular device (destination device), wherein the information is routed through the network element 102 (e.g., forwarded to a gateway general packet radio service support node or long term evolution gateway).

In another example, if the call is to be placed from a cellular device to a digital mobile radio unit, the appropriate routing number is input into the cellular device (e.g., by a user through interaction with a keyboard, touch screen, voice activation, and so forth). The call is routed through the network element 102 (e.g., forwarded from a gateway general packet radio service support node or long term evolution gateway).

Also included in the network element 102 can be an identification manager 204 that can be configured to correspond or match the identifier (e.g., identifier 120 of FIG. 1) with a device type and a protocol type. For example, the identification manager 204 can be configured to access a database 124 that includes a conversion table. As discussed with respect to FIG. 1, the database 124 can be internal to memory 108, external to memory 108, and/or external to network element 102. The conversion table can include a listing of identifiers and an association between each identifier, its device type, and its associated protocol type. Although referred to as a conversion table, the various aspects disclosed herein are not limited to a conversion table. Instead, other types of information storage formats can be utilized with the disclosed aspects, provided the destination device identifier can be associated with a device type and a protocol type. For example, a catalog can be included in database 124, wherein digital mobile radio device profiles are provisioned in the catalog.

It is noted that a database can include volatile memory or nonvolatile memory, or can include both volatile memory and nonvolatile memory. By way of illustration, and not limitation, nonvolatile memory can include read only memory, programmable read only memory, electrically programmable read only memory, electrically erasable programmable read only memory, or flash memory. Volatile memory can include random access memory, which can operate as external cache memory. By way of illustration and not limitation, random access memory is available in many forms such as static random access memory, dynamic random access memory, synchronous dynamic random access memory, double data rate synchronous dynamic random access memory, enhanced synchronous dynamic random access memory, Synchlink dynamic random access memory, and direct Rambus random access memory. The memory (e.g., data stores, databases, and so on) of the various disclosed aspects is intended to comprise, without being limited to, these and any other suitable types of memory.

The receiver 202 can also be configured to receive, from the source device, a communication 122 directed to the target device. For example, the communication can be received at about the same time as the identifier is received. However, according to some aspects, the communication is received at a different time (e.g., after the call is connected to the destination device). In the case of a voice call, the communication can be a back and forth communication, wherein the communication is received from both the source device and the destination device. In an example, the communication can be a Voice over Internet protocol (VoIP) communication (e.g., Voice over Internet protocol (VoIP) packets).

Also included in network element 102 can be a conversion manager 206 that can be configured to translate the communication from a protocol used by the source device to the protocol type of the target device to generate a translated communication. For example, the protocol of the source device can be a first protocol type and the protocol of the destination device can be a second protocol type, wherein the first protocol type and the second protocol type are different. According to an implementation, the first protocol type can be Voice over Internet protocol (VoIP) and the second protocol type can be a digital mobile radio protocol. In another example, the first protocol type can be a digital mobile radio protocol and the second protocol type can be Voice over Internet protocol (VoIP).

A transmitter 208 is configured to initiate transmission of the translated communication 210 to the target device. For example, the translated communication can be sent to the target device through the appropriate gateway (e.g., long term evolution (LTE) gateway, gateway general packet radio service support node (GGSN), and so forth). The gateway to which to route the communication can be determined based on information contained in the identifier 120, according to an aspect.

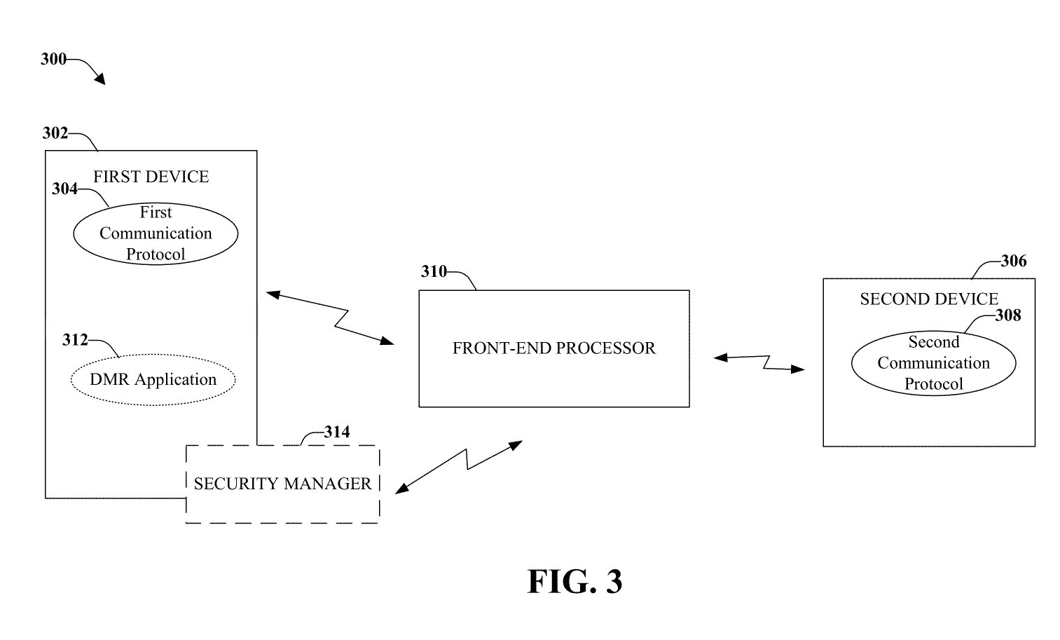

FIG. 3 illustrates an example, non-limiting system 300 configured to facilitate communication between devices that utilize different communication protocols, according to an aspect. System 300 can be configured to facilitate communication between a first device 302 (e.g., source device 104 of FIG. 1) that utilizes a first communication protocol 304 and a second device 306 (e.g., destination device 106 of FIG. 1) that utilizes a second communication protocol 308. For example, the first device can be a digital mobile radio unit that utilizes a digital mobile radio protocol and the second device can be a mobile communication device that utilizes Voice over Internet protocol. In another example, the first device can be a 3G device, a 4G device, or another communications device that utilizes Voice over Internet protocol and the second device can be a digital mobile radio unit that utilizes a digital mobile radio protocol. Although discussed herein with respect to digital mobile radio and/or Voice over Internet protocol (VoIP), it is noted that the disclosed aspects are not limited to digital mobile radio and/or Voice over Internet protocol implementations and the disclosed aspects can be utilized with other technologies.

Also included in system 100 is a front-end processor 310 (e.g., network element 102 of FIG. 1) that can be configured to interface with first device 302 and second device 306. For example, front-end processor 310 can be configured to interface with a digital mobile radio unit through a digital mobile radio gateway. In another example, front-end processor 310 can be configured to interface with a 3G enabled device through a gateway general packet radio service support node. According to another example, front-end processor 310 can be configured to interface with a long term evolution enabled device through a long term evolution gateway.

According to an implementation in which the first device 302 is a device that utilizes a cellular network (e.g., is a non-digital mobile radio unit), a digital mobile radio application 312 can reside on the device. For example, if a user of the device would like to have the capabilities to communicate with the user of a digital mobile radio unit, an application can be downloaded to the device. According to some aspects, the digital mobile radio application can be installed on any device (e.g., any cellular device).

According to some aspects, the digital mobile radio application can be installed provided the device (or device user) has the proper credentials. Thus, the downloading of the digital mobile radio application to a particular user equipment can be restricted. For example, credentials of a user (e.g., of the first device) can be authenticated by a security manager 314. Security manager 314 can be configured to selectively provide security access to allow devices of different protocols to communicate with each other.

As illustrated, the security manager 314 can be included, at least partially, on the first device 302. According to some aspects, security manager 314 can be included, at least partially, in front-end processor 310. However, according to some aspects, security manager 314 is associated with a separate or different network entity (e.g., a second front-end processor).

The digital mobile radio application 312 can be purchased and/or installed on the device in a manner to similar to how other applications are installed on devices. For example, during an initial installation of the digital mobile radio application there can be a configuration, which can be facilitated by security manager 314 (or a server) that verifies security. For example, the security manager 314 can include a database that includes profiles of users authorized to interface with the digital mobile radio application. The downloading (e.g., installation) of applications on devices is known to those of skill in the art and so will not be further described herein.

In accordance with an implementation, the security manager 314 can interface with the front-end processor 310. For example, when a session is to be established between the first device and the second device, the security manager 314 can verify security and might download a table (or other database) of destinations with which the digital mobile radio application residing on the first device would interact. The information related to the destinations can be relayed to the digital mobile radio application and used be the digital mobile radio application to facilitate communications between the first device and the second device (or another device).

Further to this implementation, the digital mobile radio application 312 can be configured to transform the data (e.g., communication) to be sent from the first device to a protocol that would be recognized by the second device. For example, the digital mobile radio application can convert the communication from the first communication protocol 304 to the second communication protocol 308. For example, the communication can be converted from Voice over Internet protocol packets into digital mobile radio voice or data protocols. This conversion can be performed by the digital mobile radio application 312 executing on the first device 304, according to an aspect.

The first device can be configured to transmit the native digital mobile radio voice and/or data protocol (e.g., converted communication) to the front-end processor. The front-end processor 310 conveys the converted communication to the second device 306. For example, the front-end processor sends the converted communication to a digital mobile radio gateway, which routes the converted communication to the digital mobile radio unit.

In the implementation where the first device is a digital mobile radio unit, the front-end processor 310 can transform the communication from the digital mobile radio protocol to Voice over Internet protocol, for example. Further, communications received from the second device 306 (e.g., in reply to a communication from the first device 302) can be converted by the front-end processor 310 (or digital mobile radio application 312) into the protocol used by the first device 302.

In such a manner, system 300 can be configured to provide digital mobile radio devices and cellular devices the ability to communicate with each other, which makes the cellular network an extension of the digital mobile radio network. Likewise, the digital mobile radio network can be an extension of the cellular network according to the various aspects disclosed herein.

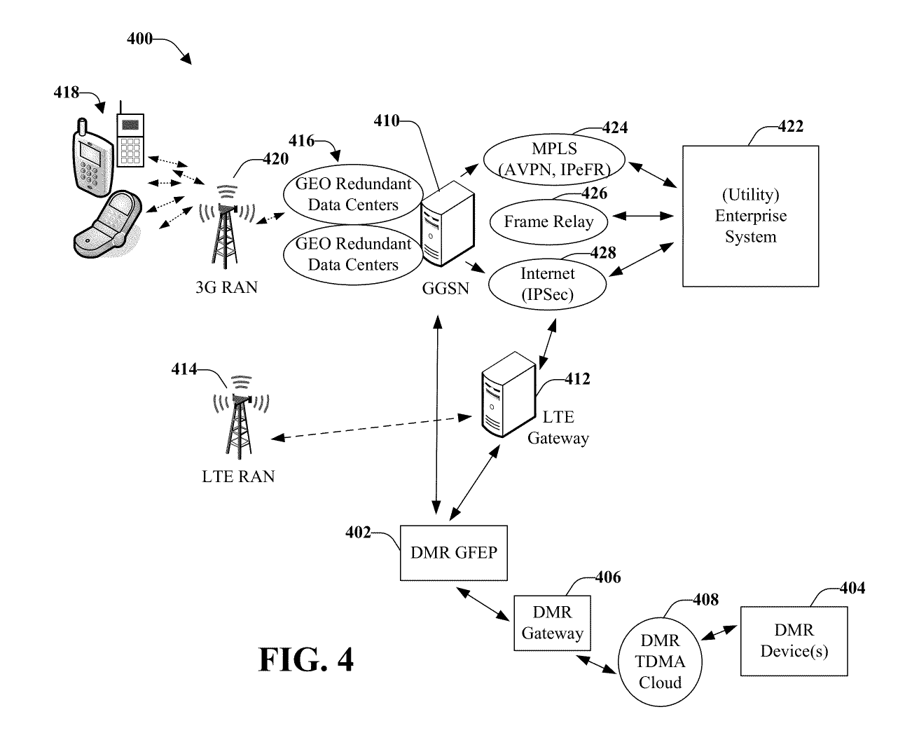

FIG. 4 illustrates an example, non-limiting wireless communications network 400 in which the disclosed aspects can be utilized. Advantages of using the disclosed aspects include the ability of mobile devices using the 3G or long term evolution network to communicate with digital mobile radio devices (e.g., radios). The bridging of these networks (e.g., cellular and digital mobile radio networks) can allow the mobile cellular systems to operate as an extension of digital mobile radio networks. In a similar manner, the digital mobile radio networks can operate as an extension of the mobile cellular systems.

Included in wireless communications network 400 is at least one digital mobile radio gateway front end processor 402 that communicates to digital mobile radio devices 404 through a digital mobile radio gateway 406 and a digital mobile radio time division multiple access cloud 408. The digital mobile radio gateway front end processor 402 also communicates with a gateway general packet radio service support node 410 and a long term evolution gateway 412. Also included in the wireless communications network 400 is a long term evolution radio access network 414, with which the long term evolution gateway 412 communicates.

The gateway general packet radio service support node 410, which can communicate over transmission control protocols and/or Internet protocol protocols, can be associated with geo redundant data centers 416 that communicate with a plurality of devices 418 (e.g., mobile communications devices, user equipment, and so forth) through a 3G radio access network 420, for example.

The long term evolution gateway 412 and/or gateway general packet radio service support node 410 can communicate with a digital mobile radio enterprise system 422 (e.g., an enterprise system of a utility), through various protocols including, but not limited to, multiprotocol label switching 424, such as a virtual private network and/or Internet protocol enabled frame relay. Other protocols include, but are not limited to, frame relay 426 and/or Internet (e.g., IPSec) 428.

In accordance with some aspects, a security processor (not shown) can be included in wireless communications network 400. The security processor can be separate from the digital mobile radio gateway front end processor 402 or can be included in the digital mobile radio gateway front end processor 402. The security processor can comprise (or can have access to) security profiles. The security processor, when separate from the digital mobile radio gateway front end processor, can offload various functions from the digital mobile radio gateway front end processor. Such functions can include, but are not limited to, security interface, authentication and key agreement (AKA), and provisioning.

Further to this aspect, a mobile device, such as a smart phone, can communicate directly with the digital mobile radio gateway front end processor or can establish a first session with the security processor. The appropriate codes and provisioning information set up with the smart phone can communicate with the digital mobile radio gateway front end processor 402, which can communicate with the digital mobile radio gateway 406, which can communicate indirectly with the digital mobile radio units 404 (e.g., through the digital mobile radio time division multiple access cloud 408).

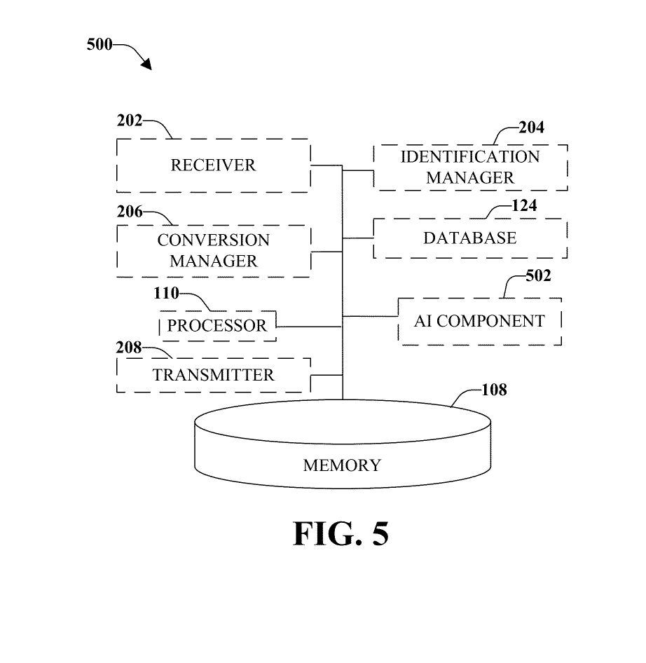

FIG. 5 illustrates an example, non-limiting system 500 that employs an artificial intelligence component 502, which can facilitate automating one or more features in accordance with the disclosed aspects. A memory 108, a processor 110, a receiver 202, an identification manager 204, a database 124, a transmitter 208, and a conversion manager 206 as well as other components (not illustrated) can include functionality, as more fully described herein, for example, with regard to the previous figures. The disclosed aspects in connection with digital mobile radio communications can employ various artificial intelligence-based schemes for carrying out various aspects thereof. For example, a process for receiving a device identity, associating the device identity with a communication protocol, converting a format of a received communication to a communication that conforms with the communication protocol, and sending the converted communication to the target device can be facilitated with an example automatic classifier system and process. In another example, a process for authenticating a sending device (e.g., source device) and/or a receiving device (e.g., target device) can be facilitated with the example automatic classifier system and process.

An example classifier can be a function that maps an input attribute vector, x=(x1, x2, x3, x4, xn), to a confidence that the input belongs to a class, that is, f(x)=confidence(class). Such classification can employ a probabilistic and/or statistical-based analysis (e.g., factoring into the analysis utilities and costs) to prognose or infer an action that can be automatically performed. In the case of communication systems, for example, attributes can be communication protocols and/or supported protocols and the classes can be conversion capabilities.

A support vector machine is an example of a classifier that can be employed. The support vector machine can operate by finding a hypersurface in the space of possible inputs, which the hypersurface attempts to split the triggering criteria from the non-triggering events. Intuitively, this makes the classification correct for testing data that is near, but not identical to training data. Other directed and undirected model classification approaches include, for example, naïve Bayes, Bayesian networks, decision trees, neural networks, fuzzy logic models, and probabilistic classification models providing different patterns of independence can be employed. Classification as used herein also may be inclusive of statistical regression that is utilized to develop models of priority.

The disclosed aspects can employ classifiers that are explicitly trained (e.g., via a generic training data) as well as implicitly trained (e.g., via observing network usage, observing network performance statistics, and so on). For example, support vector machines can be configured via a learning or training phase within a classifier constructor and feature selection module. Thus, the classifier(s) can be used to automatically learn and perform a number of functions, including but not limited to determining a protocol that is supported by a receiving device, analyzing a protocol of the communication, and converting a format of the communication to the supported protocol, and so forth. The criteria can include, but is not limited to, security credentials, application support, and so on.

In view of the example systems shown and described herein, methods that may be implemented in accordance with the one or more of the disclosed aspects, will be better understood with reference to the following flow charts. While, for purposes of simplicity of explanation, the methods are shown and described as a series of blocks, it is to be understood that the disclosed aspects are not limited by the number or order of blocks, as some blocks may occur in different orders and/or at substantially the same time with other blocks from what is depicted and described herein. Moreover, not all illustrated blocks may be required to implement the methods described hereinafter. It is noted that the functionality associated with the blocks may be implemented by software, hardware, a combination thereof or any other suitable means (e.g. device, system, process, component). Additionally, it is also noted that the methods disclosed hereinafter and throughout this specification are capable of being stored on an article of manufacture to facilitate transporting and transferring such methodologies to various devices. Those skilled in the art will understand that a method could alternatively be represented as a series of interrelated states or events, such as in a state diagram. The various methods disclosed herein can be performed by a system comprising at least one processor.

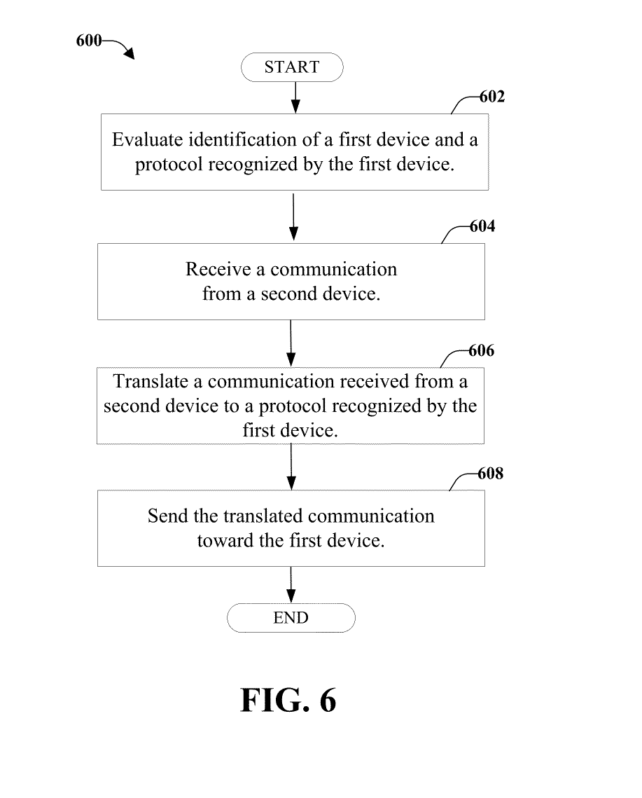

FIG. 6 illustrates an example, non-limiting method 600 for facilitating communication between devices that use different communication protocols, according to an aspect. According to an implementation, method 600 can be configured to allow digital mobile radio units, which utilize a digital mobile radio protocol, to communicate with other mobile communication devices that use a different communication protocol. For example, the other mobile communication devices can utilize a voice over Internet protocol, wherein method 600 can transform the communication from the digital mobile radio protocol to the voice over Internet protocol.

Method 600 starts, at 602, when an identification of a first device is evaluated to determine a first communication protocol used by the first device. The first device can be a destination device (e.g., a device to which a call is being made) and the identification can be received from a second device (e.g., a device on which the call is being placed). For example, a communication can originate at the second device and is intended to be received at the first device. According to an implementation, the first device can use a first communication protocol and the second device can use a second communication protocol, which is different from the first communication protocol.

The first communication protocol can be a digital mobile radio protocol and the second communication protocol can be a voice over Internet protocol. According to another aspect, the first communication protocol can be a voice over Internet protocol and the second communication protocol can be a digital mobile radio protocol. The communication protocol used by the first device (e.g., recognized by the first device) can be included in the identification of the first device and/or can be determined based on an evaluation of the identification.

The identification of the first device can include information regarding the first device. The information can include an Internet protocol address, codes, and/or security profiles of the first device. The information (or profiles) can include routing codes that detail which gateway device to use to relay the communication to the destination device. For example, if the first device is a digital mobile radio unit, the information can include a routing code for a digital mobile radio gateway device. According to another example, if the first device is a cellular phone (or another type of mobile communications device), the information can include a routing code for a long term evolution gateway device and/or for a gateway general packet radio service support node device.

At 604, a communication, directed to the first device and that originated at a second device, is received. At 606, the communication received from the second device is translated from the second communication protocol to the first communication protocol resulting in a translated communication. The translation can be transparent to the source device and/or the target device. For example, neither device can be aware that the communication sent and/or received is being translated into a different protocol format. According to some aspects, one or both of the devices are aware that the communication is being translated into a different communication protocol format.

The translated communication is sent to the first device, at 608. According to an aspect, translating the communication includes receiving the translated communication from the second device and sending the translated communication comprises directing the translated communication to a digital mobile radio gateway device. According to another aspect, translating the communication includes receiving the translated communication from a digital mobile radio gateway front end processor and the sending the translated communication comprises conveying the translated communication to a long term evolution (LTE) gateway device. In accordance with another aspect, translating the communication includes receiving the translated communication from a digital mobile radio gateway front-end processor and sending the translated communication comprises conveying the translated communication to a global system for mobile communications gateway device.

According to an implementation, the first communication protocol is a digital mobile radio protocol and the second communication protocol is a voice over Internet protocol. Translating the communication can include converting a format of the communication from the voice over Internet protocol to the digital mobile radio protocol and sending the communication can include directing the translated communication to a digital mobile radio unit.

In accordance with another implementation, the first communication protocol is a voice over Internet protocol and the second communication protocol is a digital mobile radio protocol. Further to this aspect, translating the communication, at 604, comprises converting a format of the communication from the digital mobile radio protocol to the voice over Internet protocol. Sending the communication can include directing the translated communication to a gateway general packet radio service support node.

According to another implementation, the first communication protocol is a voice over Internet protocol and the second communication protocol is a digital mobile radio protocol. Translating the communication, at 604, can include converting a format of the communication from the digital mobile radio protocol to the voice over Internet protocol. Further, sending the communication, at 606, can include directing the translated communication to a long term evolution gateway.

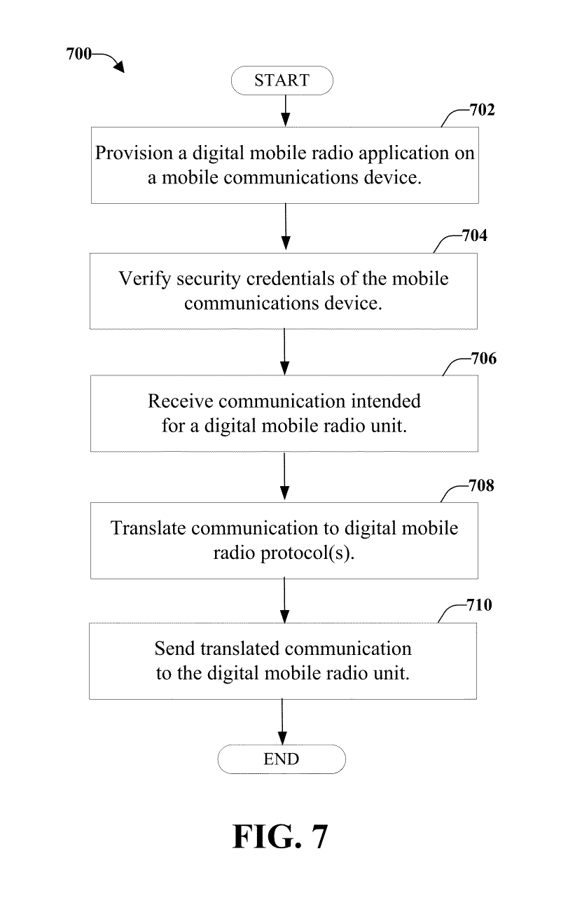

FIG. 7 illustrates an example, non-limiting method 700 for provisioning a device for communication with a digital mobile radio unit, according to an aspect. Method 700 starts, at 702, when a digital mobile radio application is provisioned on a mobile communications device. For example, when a user desires to communicate with another user (that utilizes a digital mobile radio unit), the user can select and download a digital mobile radio application on their mobile communications device. The digital mobile radio application can be downloaded from an application store or from a third-party entity that provides access to the digital mobile radio application.

At about the same time as the digital mobile radio application is downloaded to the device, or at about the same time as the digital mobile radio application is used for the first time, security credentials of the device are verified, at 704. For example, a user of the device might be presented with a prompt (e.g., on a display) to enter security information, such as a user name, logon information, or other data that can be utilized to verify the identification of the user. Based on the information that is provided in response to the request, a database can be accessed to determine if the user has the proper security credentials. If not, the digital mobile radio application can be uninstalled from the device and/or disabled. If the security credentials are verified, the user can use the digital mobile radio application to communicate with one or more digital mobile radio units.

At 706, a communication intended to be sent to a digital mobile radio unit is received. For example, the communication can be a Voice over Internet protocol communication and, based on the identification of the digital mobile radio unit, it can be decided that the Voice over Internet protocol communication should be translated into a digital mobile radio protocol. For example, the Voice over Internet protocol can be translated into digital mobile radio voice or data protocols, at 708. The translated communication can be conveyed to the digital mobile radio unit, at 710. For example, the translated communication can be sent to a digital mobile radio gateway, which conveys the translated communication to the digital mobile radio unit.

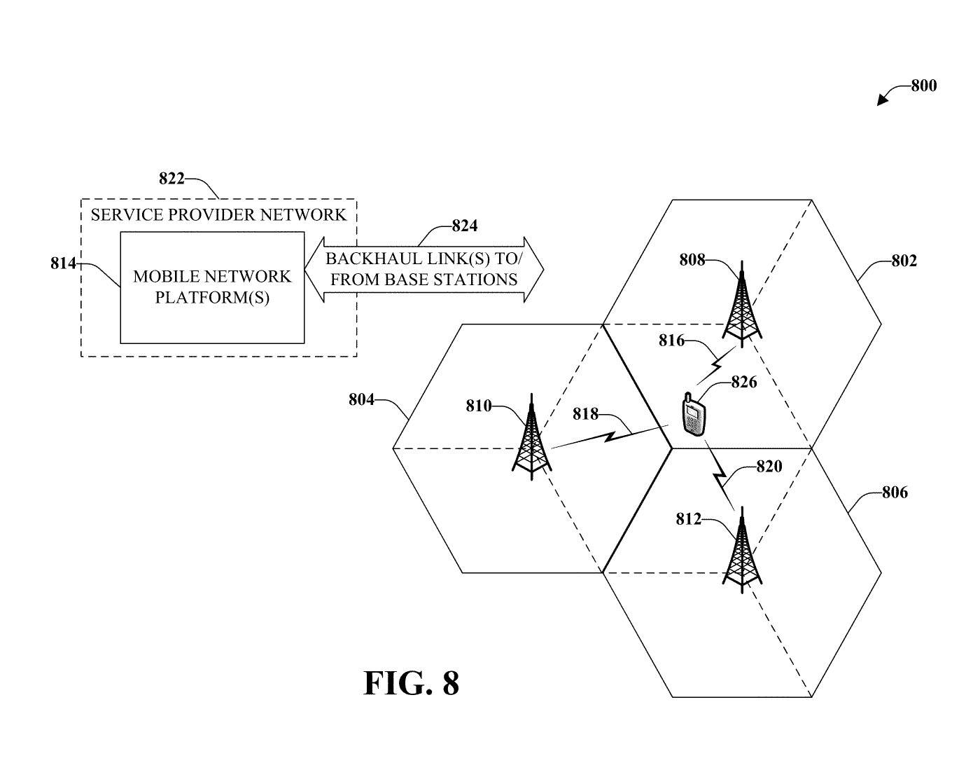

By way of further description with respect to one or more non-limiting ways to facilitate communications between digital mobile radio units and cellular devices, FIG. 8 is a schematic example wireless environment 800 that can operate in accordance with aspects described herein. In particular, example wireless environment 800 illustrates a set of wireless network macro cells. Three coverage macro cells 802, 804, and 806 include the illustrative wireless environment; however, it is noted that wireless cellular network deployments can encompass any number of macro cells. Coverage macro cells 802, 804, and 806 are illustrated as hexagons; however, coverage cells can adopt other geometries generally dictated by a deployment configuration or floor plan, geographic areas to be covered, and so on. Each macro cell 802, 804, and 806 is sectorized in a 2π/3 configuration in which each macro cell includes three sectors, demarcated with dashed lines in FIG. 8. It is noted that other sectorizations are possible, and aspects or features of the disclosed subject matter can be exploited regardless of type of sectorization. Macro cells 802, 804, and 806 are served respectively through base stations or eNodeBs 808, 810, and 812. Any two eNodeBs can be considered an eNodeB site pair. It is noted that radio component(s) are functionally coupled through links such as cables (e.g., RF and microwave coaxial lines), ports, switches, connectors, and the like, to a set of one or more antennas that transmit and receive wireless signals (not illustrated). It is noted that a radio network controller (not shown), which can be a part of mobile network platform(s) 814, and set of base stations (e.g., eNode B 808, 810, and 812) that serve a set of macro cells; electronic circuitry or components associated with the base stations in the set of base stations; a set of respective wireless links (e.g., links 816, 818, and 820) operated in accordance to a radio technology through the base stations, form a macro radio access network. It is further noted that, based on network features, the radio controller can be distributed among the set of base stations or associated radio equipment. In an aspect, for universal mobile telecommunication system-based networks, wireless links 816, 818, and 820 embody a Uu interface (universal mobile telecommunication system Air Interface).

Mobile network platform(s) 814 facilitates circuit switched-based (e.g., voice and data) and packet-switched (e.g., Internet protocol, frame relay, or asynchronous transfer mode) traffic and signaling generation, as well as delivery and reception for networked telecommunication, in accordance with various radio technologies for disparate markets. Telecommunication is based at least in part on standardized protocols for communication determined by a radio technology utilized for communication. In addition, telecommunication can exploit various frequency bands, or carriers, which include any electromagnetic frequency bands licensed by the service provider network 822 (e.g., personal communication services, advanced wireless services, general wireless communications service, and so forth), and any unlicensed frequency bands currently available for telecommunication (e.g., the 2.4 GHz industrial, medical and scientific band or one or more of the 5 GHz set of bands). In addition, mobile network platform(s) 814 can control and manage base stations 808, 810, and 812 and radio component(s) associated thereof, in disparate macro cells 802, 804, and 806 by way of, for example, a wireless network management component (e.g., radio network controller(s), cellular gateway node(s), etc.) Moreover, wireless network platform(s) can integrate disparate networks (e.g., Wi-Fi network(s), femto cell network(s), broadband network(s), service network(s), enterprise network(s), and so on). In cellular wireless technologies (e.g., third generation partnership project universal mobile telecommunication system, global system for mobile communication, mobile network platform 814 can be embodied in the service provider network 822.

In addition, wireless backhaul link(s) 824 can include wired link components such as T1/E1 phone line; T3/DS3 line, a digital subscriber line either synchronous or asynchronous; an asymmetric digital subscriber line; an optical fiber backbone; a coaxial cable, etc.; and wireless link components such as line-of-sight or non-line-of-sight links which can include terrestrial air-interfaces or deep space links (e.g., satellite communication links for navigation). In an aspect, for universal mobile telecommunication system-based networks, wireless backhaul link(s) 824 embodies IuB interface.

It is noted that while exemplary wireless environment 800 is illustrated for macro cells and macro base stations, aspects, features and advantages of the disclosed subject matter can be implemented in micro cells, pico cells, femto cells, or the like, wherein base stations are embodied in home-based equipment related to access to a network.

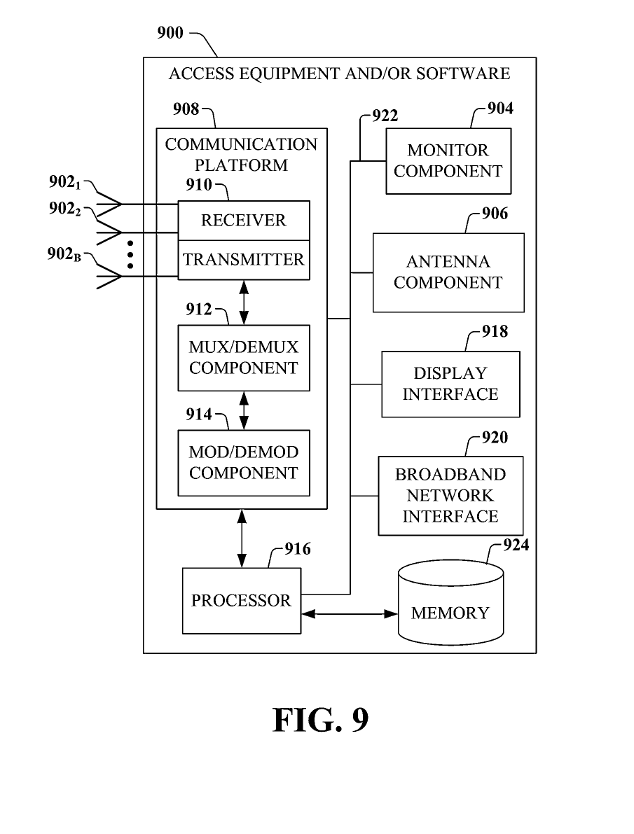

To provide further context for various aspects of the disclosed subject matter, FIG. 9 illustrates a block diagram of an embodiment of access equipment and/or software 900 related to access of a network (e.g., base station, wireless access point, femtocell access point, and so forth) that can enable and/or exploit features or aspects of the disclosed aspects.

Access equipment and/or software 900 related to access of a network can receive and transmit signal(s) from and to wireless devices, wireless ports, wireless routers, etc. through segments 902₁-902_{B} (B is a positive integer). Segments 902₁-902_{B} can be internal and/or external to access equipment and/or software 900 related to access of a network, and can be controlled by a monitor component 904 and an antenna component 906. Monitor component 904 and antenna component 906 can couple to communication platform 908, which can include electronic components and associated circuitry that provide for processing and manipulation of received signal(s) and other signal(s) to be transmitted.

In an aspect, communication platform 908 includes a receiver/transmitter 910 that can convert analog signals to digital signals upon reception of the analog signals, and can convert digital signals to analog signals upon transmission. In addition, receiver/transmitter 910 can divide a single data stream into multiple, parallel data streams, or perform the reciprocal operation. Coupled to receiver/transmitter 910 can be a multiplexer/demultiplexer 912 that can facilitate manipulation of signals in time and frequency space. Multiplexer/demultiplexer 912 can multiplex information (data/traffic and control/signaling) according to various multiplexing schemes such as time division multiplexing, frequency division multiplexing, orthogonal frequency division multiplexing, code division multiplexing, space division multiplexing. In addition, multiplexer/demultiplexer component 912 can scramble and spread information (e.g., codes, according to substantially any code known in the art, such as Hadamard-Walsh codes, Baker codes, Kasami codes, polyphase codes, and so forth).

A modulator/demodulator 914 is also a part of communication platform 908, and can modulate information according to multiple modulation techniques, such as frequency modulation, amplitude modulation (e.g., M-ary quadrature amplitude modulation, with M a positive integer); phase-shift keying; and so forth).

Access equipment and/or software 900 related to access of a network also includes a processor 916 configured to confer, at least in part, functionality to substantially any electronic component in access equipment and/or software 900. In particular, processor 916 can facilitate configuration of access equipment and/or software 900 through, for example, monitor component 904, antenna component 906, and one or more components therein. Additionally, access equipment and/or software 900 can include display interface 918, which can display functions that control functionality of access equipment and/or software 900, or reveal operation conditions thereof. In addition, display interface 918 can include a screen to convey information to an end user. In an aspect, display interface 918 can be a liquid crystal display), a plasma panel, a monolithic thin-film based electrochromic display, and so on. Moreover, display interface 918 can include a component (e.g., speaker) that facilitates communication of aural indicia, which can also be employed in connection with messages that convey operational instructions to an end user. Display interface 918 can also facilitate data entry (e.g., through a linked keypad or through touch gestures), which can cause access equipment and/or software 900 to receive external commands (e.g., restart operation).

Broadband network interface 920 facilitates connection of access equipment and/or software 900 to a service provider network (not shown) that can include one or more cellular technologies (e.g., third generation partnership project universal mobile telecommunication system, global system for mobile communication, and so on.) through backhaul link(s) (not shown), which enable incoming and outgoing data flow. Broadband network interface 920 can be internal or external to access equipment and/or software 900, and can utilize display interface 918 for end-user interaction and status information delivery.

Processor 916 can be functionally connected to communication platform 908 and can facilitate operations on data (e.g., symbols, bits, or chips) for multiplexing/demultiplexing, such as effecting direct and inverse fast Fourier transforms, selection of modulation rates, selection of data packet formats, inter-packet times, and so on. Moreover, processor 916 can be functionally connected, through data, system, or an address bus 922, to display interface 918 and broadband network interface 920, to confer, at least in part, functionality to each of such components.

In access equipment and/or software 900, memory 924 can retain location and/or coverage area (e.g., macro sector, identifier(s)), access list(s) that authorize access to wireless coverage through access equipment and/or software 900, sector intelligence that can include ranking of coverage areas in the wireless environment of access equipment and/or software 900, radio link quality and strength associated therewith, or the like. Memory 924 also can store data structures, code instructions and program modules, system or device information, code sequences for scrambling, spreading and pilot transmission, access point configuration, and so on. Processor 916 can be coupled (e.g., through a memory bus), to memory 924 in order to store and retrieve information used to operate and/or confer functionality to the components, platform, and interface that reside within access equipment and/or software 900.

As it employed in the subject specification, the term “processor” can refer to substantially any computing processing unit or device including, but not limited to including, single-core processors; single-processors with software multithread execution capability; multi-core processors; multi-core processors with software multithread execution capability; multi-core processors with hardware multithread technology; parallel platforms; and parallel platforms with distributed shared memory. Additionally, a processor can refer to an integrated circuit, an application specific integrated circuit, a digital signal processor, a field programmable gate array, a programmable logic controller, a complex programmable logic device, a discrete gate or transistor logic, discrete hardware components, or any combination thereof designed to perform the functions and/or processes described herein. Processors can exploit nano-scale architectures such as, but not limited to, molecular and quantum-dot based transistors, switches and gates, in order to optimize space usage or enhance performance of mobile devices. A processor may also be implemented as a combination of computing processing units.

In the subject specification, terms such as “store,” “data store,” data storage,” “database,” and substantially any other information storage component relevant to operation and functionality of a component and/or process, refer to “memory components,” or entities embodied in a “memory,” or components including the memory. It is noted that the memory components described herein can be either volatile memory or nonvolatile memory, or can include both volatile and nonvolatile memory.

By way of illustration, and not limitation, nonvolatile memory, for example, can be included in memory 924, non-volatile memory (see below), disk storage (see below), and memory storage (see below). Further, nonvolatile memory can be included in read only memory, programmable read only memory, electrically programmable read only memory, electrically erasable programmable read only memory, or flash memory. Volatile memory can include random access memory, which acts as external cache memory. By way of illustration and not limitation, random access memory is available in many forms such as synchronous random access memory, dynamic random access memory, synchronous dynamic random access memory, double data rate synchronous dynamic random access memory, enhanced synchronous dynamic random access memory, Synchlink dynamic random access memory, and direct Rambus random access memory. Additionally, the disclosed memory components of systems or methods herein are intended to include, without being limited to including, these and any other suitable types of memory.

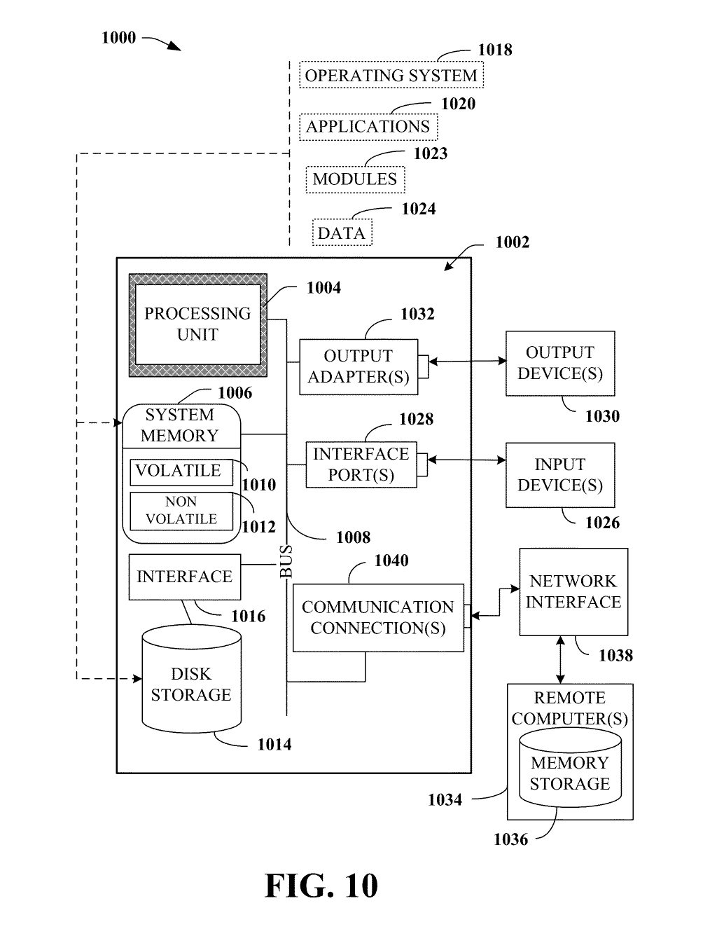

In order to provide a context for the various aspects of the disclosed subject matter, FIG. 10, and the following discussion, are intended to provide a brief, general description of a suitable environment in which the various aspects of the disclosed subject matter can be implemented. While the subject matter has been described above in the general context of computer-executable instructions of a computer program that runs on a computer and/or computers, those skilled in the art will recognize that the various aspects also can be implemented in combination with other program modules. Generally, program modules include routines, programs, components, data structures, etc. that perform particular tasks and/or implement particular abstract data types. For example, in memory (such as memory 108) there can be software, which can instruct a processor (such as processor 110) to perform various actions. The processor can be configured to execute the instructions in order to implement the analysis of monitoring an uplink power level, detecting the uplink power level is at or above a threshold level, and/or disable transmission of at least one message as a result of the monitored uplink power level.

Moreover, those skilled in the art will understand that the various aspects can be practiced with other computer system configurations, including single-processor or multiprocessor computer systems, mini-computing devices, mainframe computers, as well as personal computers, base stations hand-held computing devices or user equipment, such as a tablet, phone, watch, and so forth, processor-based computers/systems, microprocessor-based or programmable consumer or industrial electronics, and the like. The illustrated aspects can also be practiced in distributed computing environments where tasks are performed by remote processing devices that are linked through a communications network; however, some if not all aspects of the subject disclosure can be practiced on stand-alone computers. In a distributed computing environment, program modules can be located in both local and remote memory storage devices.

With reference to FIG. 10, a block diagram of a computing system 1000 operable to execute the disclosed systems and methods is illustrated, in accordance with an embodiment. Computer 1002 includes a processing unit 1004, a system memory 1006, and a system bus 1008. System bus 1008 couples system components including, but not limited to, system memory 1006 to processing unit 1004. Processing unit 1004 can be any of various available processors. Dual microprocessors and other multiprocessor architectures also can be employed as processing unit 1004.

System bus 1008 can be any of several types of bus structure(s) including a memory bus or a memory controller, a peripheral bus or an external bus, and/or a local bus using any variety of available bus architectures including, but not limited to, industrial standard architecture, micro-channel architecture, extended industrial standard architecture, intelligent drive electronics, video electronics standards association local bus, peripheral component interconnect, card bus, universal serial bus, advanced graphics port, personal computer memory card international association bus, Firewire (institute of electrical and electronics engineers 1194), and small computer systems interface.

System memory 1006 includes volatile memory 1010 and nonvolatile memory 1012. A basic input/output system, containing routines to transfer information between elements within computer 1002, such as during start-up, can be stored in nonvolatile memory 1012. By way of illustration, and not limitation, nonvolatile memory 1012 can include read only memory, programmable read only memory, electrically programmable read only memory, electrically erasable programmable read only memory, or flash memory. Volatile memory 1010 can include random access memory, which acts as external cache memory. By way of illustration and not limitation, random access memory is available in many forms such as dynamic random access memory, synchronous random access memory, synchronous dynamic random access memory, double data rate synchronous dynamic random access memory, enhanced synchronous dynamic random access memory, Synchlink dynamic random access memory, and direct Rambus random access memory, direct Rambus dynamic random access memory, and Rambus dynamic random access memory.

Computer 1002 also includes removable/non-removable, volatile/non-volatile computer storage media. In an implementation, provided is a non-transitory or tangible computer-readable medium storing computer-executable instructions that, in response to execution, cause a system comprising a processor to perform operations. The operations can include receiving, from an originating device, an identification of a destination device. The operations can also include determining that a first protocol used by the originating device is different from a second protocol used by the destination device, wherein the second protocol is derived based in part on the identification of the destination device. Further, the operations can include converting a format of the communication, received from the originating device, from the first protocol to the second protocol resulting in a reformatted communication. The operations can also include conveying the reformatted communication to a gateway device associated with the destination device, wherein the gateway is identified according to a routing code included in the identification of the destination device.

According to an implementation, the originating device is a digital mobile radio unit that is configured to use a digital mobile radio protocol and the destination device is a cellular phone that is configured to use a voice over Internet protocol. According to another implementation, the originating device is a cellular device that is configured to use Voice over Internet protocol and the destination device is a digital mobile radio unit that is configured to use a digital radio protocol.

FIG. 10 illustrates, for example, disk storage 1014. Disk storage 1014 includes, but is not limited to, devices such as a magnetic disk drive, floppy disk drive, tape drive, Jaz drive, Zip drive, superdisk drive, flash memory card, or memory stick. In addition, disk storage 1014 can include storage media separately or in combination with other storage media including, but not limited to, an optical disk drive such as a compact disk read only memory device, compact disk recordable drive, compact disk rewritable drive or a digital versatile disk read only memory drive. To facilitate connection of the disk storage 1014 to system bus 1008, a removable or non-removable interface is typically used, such as interface component 1016.

It is to be noted that FIG. 10 describes software that acts as an intermediary between users and computer resources described in suitable operating environment. Such software includes an operating system 1018. Operating system 1018, which can be stored on disk storage 1014, acts to control and allocate resources of computer system 1002. System applications 1020 can take advantage of the management of resources by operating system 1018 through program modules 1022 and program data 1024 stored either in system memory 1006 or on disk storage 1014. It is to be understood that the disclosed subject matter can be implemented with various operating systems or combinations of operating systems.

A user can enter commands or information, for example through interface component 1016, into computer system 1002 through input device(s) 1026. Input devices 1026 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to processing unit 1004 through system bus 1008 through interface port(s) 1028. Interface port(s) 1028 include, for example, a serial port, a parallel port, a game port, and a universal serial bus. Output device(s) 1030 use some of the same type of ports as input device(s) 1026.

Thus, for example, a universal serial bus port can be used to provide input to computer 1002 and to output information from computer 1002 to an output device 1030. Output adapter 1032 is provided to illustrate that there are some output devices 1030, such as monitors, speakers, and printers, among other output devices 1030, which use special adapters. Output adapters 1032 include, by way of illustration and not limitation, video and sound cards that provide means of connection between output device 1030 and system bus 1008. It is also noted that other devices and/or systems of devices provide both input and output capabilities such as remote computer(s) 1034.

Computer 1002 can operate in a networked environment using logical connections to one or more remote computers, such as remote computer(s) 1034. Remote computer(s) 1034 can be a personal computer, a server, a router, a network computer, a workstation, a microprocessor based appliance, a peer device, or other common network node and the like, and typically includes many or all of the elements described relative to computer 1002.

For purposes of brevity, only one memory storage device 1036 is illustrated with remote computer(s) 1034. Remote computer(s) 1034 is logically connected to computer 1002 through a network interface 1038 and then physically connected through communication connection 1040. Network interface 1038 encompasses wire and/or wireless communication networks such as local area networks and wide area networks. Local area network technologies include fiber distributed data interface, copper distributed data interface, Ethernet, token ring and the like. Wide area network technologies include, but are not limited to, point-to-point links, circuit switching networks like integrated services digital networks and variations thereon, packet switching networks, and digital subscriber lines.

Communication connection(s) 1040 refer(s) to hardware/software employed to connect network interface 1038 to system bus 1008. While communication connection 1040 is shown for illustrative clarity inside computer 1002, it can also be external to computer 1002. The hardware/software for connection to network interface 1038 can include, for example, internal and external technologies such as modems, including regular telephone grade modems, cable modems and DSL modems, ISDN adapters, and Ethernet cards.

It is to be noted that aspects, features, or advantages of the aspects described in the subject specification can be exploited in substantially any communication technology. For example, 4G technologies, Wi-Fi, worldwide interoperability for microwave access, Enhanced gateway general packet radio service, third generation partnership project long term evolution, third generation partnership project 2 ultra mobile broadband, third generation partnership project universal mobile telecommunication system, high speed packet access, high-speed downlink packet access, high-speed uplink packet access, global system for mobile communication edge radio access network, universal mobile telecommunication system terrestrial radio access network, long term evolution advanced. Additionally, substantially all aspects disclosed herein can be exploited in legacy telecommunication technologies; e.g., global system for mobile communication. In addition, mobile as well non-mobile networks (e.g., Internet, data service network such as Internet protocol television) can exploit aspect or features described herein.

Various aspects or features described herein can be implemented as a method, apparatus, or article of manufacture using standard programming and/or engineering techniques. In addition, various aspects disclosed in the subject specification can also be implemented through program modules stored in a memory and executed by a processor, or other combination of hardware and software, or hardware and firmware.

Other combinations of hardware and software or hardware and firmware can enable or implement aspects described herein, including disclosed method(s). The term “article of manufacture” as used herein is intended to encompass a computer program accessible from any computer-readable device, carrier, or media. For example, computer readable media can include but are not limited to magnetic storage devices (e.g., hard disk, floppy disk, magnetic strips . . . ), optical discs (e.g., compact disc, digital versatile disc, blu-ray disc . . . ), smart cards, and flash memory devices (e.g., card, stick, key drive . . . ).

Computing devices typically include a variety of media, which can include computer-readable storage media or communications media, which two terms are used herein differently from one another as follows.

Computer-readable storage media can be any available storage media that can be accessed by the computer and includes both volatile and nonvolatile media, removable and non-removable media. By way of example, and not limitation, computer-readable storage media can be implemented in connection with any method or technology for storage of information such as computer-readable instructions, program modules, structured data, or unstructured data. Computer-readable storage media can include, but are not limited to, random access memory, read only memory, electrically erasable programmable read only memory, flash memory or other memory technology, compact disk read only memory, digital versatile disk or other optical disk storage, magnetic cassettes, magnetic tape, magnetic disk storage or other magnetic storage devices, or other tangible and/or non-transitory media which can be used to store desired information. Computer-readable storage media can be accessed by one or more local or remote computing devices, e.g., via access requests, queries or other data retrieval protocols, for a variety of operations with respect to the information stored by the medium.

Communications media typically embody computer-readable instructions, data structures, program modules or other structured or unstructured data in a data signal such as a modulated data signal, e.g., a carrier wave or other transport mechanism, and includes any information delivery or transport media. The term “modulated data signal” or signals refers to a signal that has one or more of its characteristics set or changed in such a manner as to encode information in one or more signals. By way of example, and not limitation, communication media include wired media, such as a wired network or direct-wired connection, and wireless media such as acoustic, RF, infrared and other wireless media.

What has been described above includes examples of systems and methods that provide advantages of the one or more aspects. It is, of course, not possible to describe every conceivable combination of components or methods for purposes of describing the aspects, but one of ordinary skill in the art may recognize that many further combinations and permutations of the claimed subject matter are possible. Furthermore, to the extent that the terms “includes,” “has,” “possesses,” and the like are used in the detailed description, claims, appendices and drawings such terms are intended to be inclusive in a manner similar to the term “comprising” as “comprising” is interpreted when employed as a transitional word in a claim.

As used in this application, the terms “component,” “system,” and the like are intended to refer to a computer-related entity or an entity related to an operational apparatus with one or more specific functionalities, wherein the entity can be either hardware, a combination of hardware and software, software, or software in execution. As an example, a component may be, but is not limited to being, a process running on a processor, a processor, an object, an executable, a thread of execution, computer-executable instructions, a program, and/or a computer. By way of illustration, both an application running on a server or network controller, and the server or network controller can be a component. One or more components may reside within a process and/or thread of execution and a component may be localized on one computer and/or distributed between two or more computers. Also, these components can execute from various computer readable media having various data structures stored thereon. The components may communicate via local and/or remote processes such as in accordance with a signal having one or more data packets (e.g., data from one component interacting with another component in a local system, distributed system, and/or across a network such as the Internet with other systems via the signal). As another example, a component can be an apparatus with specific functionality provided by mechanical parts operated by electric or electronic circuitry, which is operated by a software, or firmware application executed by a processor, wherein the processor can be internal or external to the apparatus and executes at least a part of the software or firmware application. As yet another example, a component can be an apparatus that provides specific functionality through electronic components without mechanical parts, the electronic components can include a processor therein to execute software or firmware that confers at least in part the functionality of the electronic components. As further yet another example, interface(s) can include input/output components as well as associated processor, application, or application programming interface components.

The term “set”, “subset”, or the like as employed herein excludes the empty set (e.g., the set with no elements therein). Thus, a “set”, “subset”, or the like includes one or more elements or periods, for example. As an illustration, a set of periods includes one or more periods; a set of transmissions includes one or more transmissions; a set of resources includes one or more resources; a set of messages includes one or more messages, and so forth.

In addition, the term “or” is intended to mean an inclusive “or” rather than an exclusive “or.” That is, unless specified otherwise, or clear from context, “X employs A or B” is intended to mean any of the natural inclusive permutations. That is, if X employs A; X employs B; or X employs both A and B, then “X employs A or B” is satisfied under any of the foregoing instances. Moreover, articles “a” and “an” as used in the subject specification and annexed drawings should generally be construed to mean “one or more” unless specified otherwise or clear from context to be directed to a singular form.

What is claimed is:

1. A system, comprising:
a memory to store instructions; and
a processor, communicatively coupled to the memory, that facilitates execution of the instructions to perform operations, comprising:
receiving, from a source device that utilizes a first communication protocol, an identifier representative of a target device;
matching the identifier with a device type and a second communication protocol different from the first communication protocol;
receiving, from the source device over a communication link according to the first communication protocol, a communication directed to the target device;
translating the communication from the first communication protocol to the second communication protocol to generate a translated communication, wherein the translating is transparent to the source device and the target device; and
initiating a transmission of the translated communication to the target device.

2. The system of claim 1, wherein the source device is a digital mobile radio unit.

3. The system of claim 1, wherein the target device is a digital mobile radio unit.

4. The system of claim 1, wherein the operations further comprise:
routing the translated communication to a gateway device configured to manage communications for the target device, wherein the gateway device is identified based on the device type.

5. The system of claim 4, wherein the source device is a digital mobile radio unit associated with a digital mobile radio network and the gateway device is a long term evolution gateway device associated with a mobile cellular network and wherein the translating causes the mobile cellular network to become an extension of the digital mobile radio network.

6. The system of claim 4, wherein the source device is a digital mobile radio unit associated with a digital mobile radio network and the gateway device is a gateway general packet radio service support node device associated with a mobile cellular network and wherein the translating causes the mobile cellular network to become an extension of the digital mobile radio network.

7. The system of claim 1, wherein the first communication protocol is a digital mobile radio protocol and the second communication protocol is a voice over Internet protocol.

8. The system of claim 1, wherein the first communication protocol is a voice over Internet protocol and the second communication protocol is a digital mobile radio protocol.

9. The system of claim 1, wherein the operations further comprise authenticating the source device before the translating the communication.

10. A method, comprising:
evaluating, by a system comprising a processor, an identification of a first device to determine a first communication protocol used by the first device;
receiving, by the system, a communication directed to the first device and that originated at a second device using a second communication protocol, wherein the second device is provisioned with a digital mobile radio application;
translating, by the system, the communication from the second communication protocol to the first communication protocol resulting in a translated communication; and
sending, by the system, the translated communication to the first device.

11. The method of claim 10, wherein the first communication protocol is a digital mobile radio protocol and the second communication protocol is a voice over Internet protocol, wherein the translating the communication comprises converting the communication from the voice over Internet protocol to the digital mobile radio protocol, and wherein the sending comprises directing the translated communication to a digital mobile radio unit.

12. The method of claim 10, wherein the first communication protocol is a voice over Internet protocol and the second communication protocol is a digital mobile radio protocol, wherein the translating the communication comprises converting the communication from the digital mobile radio protocol to the voice over Internet protocol, and wherein the sending comprises directing the translated communication to a gateway general packet radio service support node device.

13. The method of claim 10, wherein the first communication protocol is a voice over Internet protocol and the second communication protocol is a digital mobile radio protocol, wherein the translating the communication comprises converting the communication from the digital mobile radio protocol to the voice over Internet protocol, and wherein the sending comprises directing the translated communication to a long term evolution gateway device.

14. The method of claim 10, wherein the translating the communication includes receiving the translated communication from the second device and the sending the translated communication comprises directing the translated communication to a digital mobile radio gateway device, wherein the translating is transparent to the second device and the digital mobile radio gateway device.

15. The method of claim 10, wherein the translating the communication includes receiving the translated communication from a digital mobile radio gateway front end processor and the sending the translated communication comprises conveying the translated communication to a long term evolution gateway device, and wherein the translating is transparent to the digital mobile radio gateway front end processor and the long term evolution gateway device.

16. The method of claim 10, wherein the translating the communication includes receiving the translated communication from a digital mobile radio gateway front end processor and the sending the translated communication comprises conveying the translated communication to a global system for mobile communications gateway device.

17. The method of claim 10, wherein the first communication protocol and the second communication protocol are different communication protocols.

18. A tangible computer-readable medium storing computer-executable instructions that, in response to execution, cause a system comprising a processor to perform operations, comprising:
receiving, from an originating device, an identification of a destination device;
determining that a first protocol used by the originating device is different from a second protocol used by the destination device, wherein the second protocol is derived based on the identification of the destination device;
converting a format of a communication, received from the originating device, from the first protocol to the second protocol resulting in a reformatted communication; and
conveying the reformatted communication to a gateway device associated with the destination device, wherein the gateway device is identified according to a routing code included in the identification of the destination device.

19. The tangible computer-readable medium of claim 18, wherein the originating device is a digital mobile radio unit that is configured to use a digital mobile radio protocol and the destination device is a cellular phone that is configured to use a voice over Internet protocol.

20. The tangible computer-readable medium of claim 18, wherein the originating device is a cellular device that is configured to use Voice over Internet protocol and the destination device is a digital mobile radio unit that is configured to use a digital radio protocol.
